(19) United States
(12) Patent Application Publication
(10) Pub. No.: US 2018/0307765 A1
(43) Pub. Date: Oct. 25, 2018

(54) INTERACTIVE SYSTEM, INTERACTION METHOD, AND STORAGE MEDIUM

(71) Applicant: Kabushiki Kaisha Toshiba, Tokyo (JP)

(72) Inventors: Kenji Iwata, Machida Tokyo (JP); Hiroshi Fujimura, Yokohama Kanagawa (JP)

(21) Appl. No.: 15/916,154

(22) Filed: Mar. 8, 2018

(30) Foreign Application Priority Data
Apr. 24, 2017 (JP) 2017-085279

(51) Int. Cl. G06F 17/30

(52) U.S. Cl. CPC G06F 17/30867; G06F 17/30554; G06F 17/3053

(57) ABSTRACT

According to one embodiment, an interactive system uses at least one of the number of the retrieval result and the number of conditions told by a user to the system if a recommendable candidate is included in retrieval targets in a database which is searched with a condition obtained in the interaction with the user, and determines whether or not a behavior to present the recommendable candidate is performed is determined. Thus, the recommendable candidate can be actively recommended to the user such that the user does not feel dissatisfaction to the service.

### CROSS-REFERENCE TO RELATED APPLICATIONS

This application is based upon and claims the benefit of priority from Japanese Patent Application No. 2017-085279, filed Apr. 24, 2017, the entire contents of which are incorporated herein by reference.

### FIELD

Embodiments described herein relate generally to an interactive system, interactive method, and interaction program.

### BACKGROUND

In recent years, there are interactive systems which narrow down presentation candidates corresponding to preference of a user by interaction with the user to present candidates requested by the user, and such systems become widely used. Such interactive systems which perform retrieval interaction are used widely, namely, a shop guide post in a shopping mall, guide in a restaurant, travel guide, and the like.

Note that, in the interactive system which perform the retrieval interaction, the system may behave not only to give narrowing down conditions or candidates matching the conditions to the user (this means an operation of the system) but also to actively present recommendable candidates to the user in some cases. For example, in a shop guide post in a shopping mall, there may be a store to be recommended by the manager of the shopping mall for reasons that the shop is newly opened, the shop is selling items on a sale, the shop sells new items, or the like. In that case, an active presentation of the recommendation candidate may attract users who did not intend to go to the shop and the profit of the shopping mall may be increased.

In relation to this point, some conventional interactive systems determine their behavior to users on the basis of the number of retrieval results, user preference, past interaction history, and the like; however, they have not controlled their behavior on the basis of whether or not a recommendable candidate is included in the retrieval result.

On the other hand, even if a recommendable candidate is included in a retrieval result, active presentation of the recommendable candidate is always performed, users may be dissatisfied. That is, if a user is not interested in the candidates actively presented, the interaction to narrow down the candidates is performed by using additional conditions, and at that time, if the narrowed-down candidates still include the recommendable candidate, this candidate is actively presented to the user every time when the narrowing-down process is performed. If this process is repeated for many times, the interaction with user does not flow well, and an undesirable candidate is recommended to the user. Even if the user finally finds a desired candidate, the user may be dissatisfied by the behavior of the interactive system.

Thus, the interactive system must be controlled such that a user does not feel dissatisfaction to an active presentation of recommendable candidates. In consideration of this point, conventional interactive systems may perform active presentation by outputting a recommendable candidate in a higher rank of the retrieval result; however, the conventional interactive systems have not controlled timing of presentation of recommendable candidates such that users would not feel dissatisfaction to the service.

### BRIEF DESCRIPTION OF THE DRAWINGS

FIG. 1 is a block diagram showing the structure of an interactive system of a first embodiment.

FIG. 2 is a flowchart showing an operation of the interactive system of the first embodiment.

FIG. 3 is a block diagram showing the structure of the interactive system of the first embodiment, to which a recommendation candidate data manager is added.

FIG. 4 shows a database to be referred to in an example of the operation of the interactive system of the first embodiment.

FIG. 5 shows an example of a first action of the interactive system of the first embodiment.

FIG. 6 shows an example of a second action of the interactive system of the first embodiment.

FIG. 7 shows an example of a third action of the interactive system of the first embodiment.

FIG. 8 is a block diagram showing the structure of an interactive system of a second embodiment.

FIG. 9 is a flowchart showing an action of the interactive system of the second embodiment.

FIG. 10 shows a database to be referred to in an example of the action of the interactive system of the second embodiment.

FIG. 11 shows an example of a first action of the interactive system of the second embodiment.

FIG. 12 shows an example of a second action of the interactive system of the second embodiment.

FIG. 13 is a block diagram showing a basic structure of a computer device which can be applied to the interactive systems of FIGS. 1 to 8.

### DETAILED DESCRIPTION

In general, according to one embodiment, an interactive system includes a database and a controller. The database stores a plurality of retrieval targets to be associated with recommendation candidate data indicative of whether or not a retrieval target is a recommendation candidate. The controller sets a retrieval condition based on input data obtained from interaction with a user, retrieves a target corresponding to the retrieval condition from the database, determines whether or not a recommendation candidate is included in the retrieved target from the recommendation candidate data associated with the retrieved target, determines an action to the user based on a result of the retrieval if the recommendation candidate is determined to be not included, determines whether or not presentation of the recommendation candidate to the user is performed based on at least one of the number of the retrieved target and the number of input in the interaction with the user if the recommendation candidate is determined to be included, and performs a reply process corresponding to the determined action.

Hereinafter, embodiments of the present application will be explained with reference to the accompanying drawings.

### First Embodiment

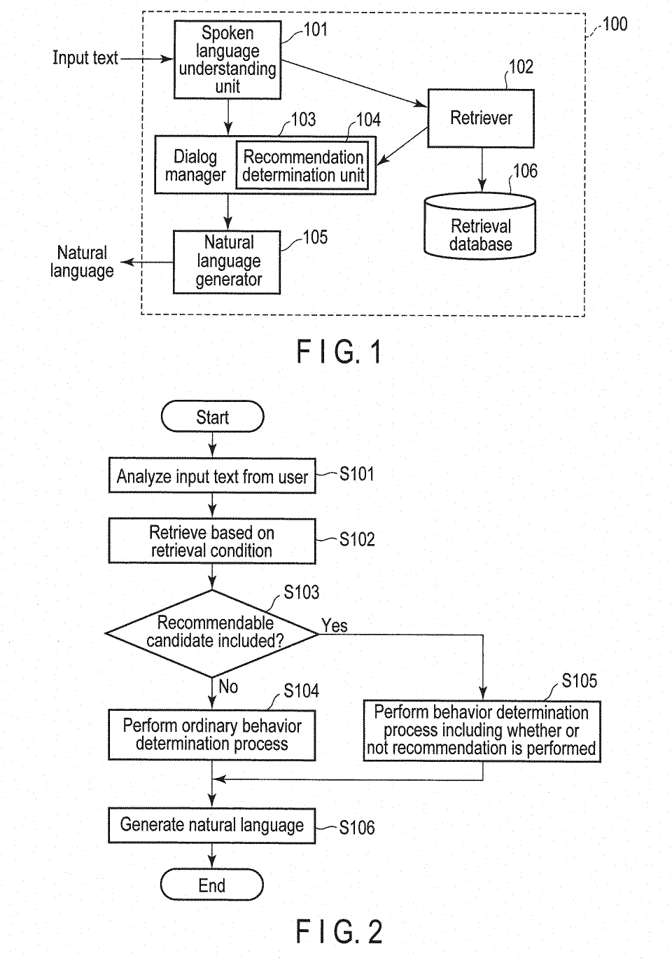

FIG. 1 is a block diagram showing the structure of an interactive system of a first embodiment.

The interactive system 100 of the first embodiment includes a spoken language understanding unit 101, retriever 102, dialog manager (true-false) 103 including a recommendation determination unit 104, natural language generator 105, and retrieval database (true-false) (hereinafter referred to as DB) 106.

The spoken language understanding unit 101 analyzes a text input by a user (hereinafter, input text) to estimate an intention of user and a retrieval condition. The estimated retrieval condition is transmitted to the retriever 102 and, at the same time, transmitted to the dialog manager 103 with the data related to the intention of user.

Here, the input text is a speech of user put through automatic speech recognition and converted into a text; however, the text may be made by other input processes such as a keyboard operation of user.

Furthermore, in order to represent the intention of user, a pair of speech tag and slot may be used. The speech tag represents a behavior of user to the system in an input text, and the tag may be sending information (inform), confirming information (confirm), giving positive reaction to a question of the system (affirm), or giving negative reaction to a question of the system (negative), or the like. The tag may be further specified such as looking for a restaurant (inform-search-restaurant), looking for a hotel (inform-search-hotel), or the like. The slot is data required for an interaction process included in the input text and is represented as [slot name (value attribution)=value]. For example, if an input text is “I want a reasonable bag”, a slot [price=reasonable] and a slot [item=bag] are extracted. The speech tags and slots may be estimated through a keyword matching method, or a statistical method on the basis of a preliminarily-learned model using feature vectors obtained from a morphological analysis, or the like. The statistical method includes a maximum entropy method, neural network, of the like.

Furthermore, representation of the retrieval condition depends on the schema of the retrieval database 106, and for example, a form corresponding to the slot; [condition (value attribution)=value] may be used. In the estimation, a preliminarily-input retrieval condition may be recorded, and a value thereof is handed over if there is no mention to the retrieval condition while the value thereof is erased if there is an input to order the erase thereof. The retrieval condition may be estimated through a combination of a condition value extraction such as keyword matching or statistic estimation method and the above-mentioned handover process described as a rule, or through a statistical method including both the condition value extraction and the handover process, or the like.

Furthermore, the input text of user may be made through a speech or direct input by keyboard, or operation data such as touch data of a graphical user interface (GUI). At the graphical user interface operation, a process to estimate the intention of user and the retrieval condition from the operation data. The estimation is generally performed rulebase.

The retriever 102 search the retrieval database 106 on the basis of the retrieval condition obtained from the spoken language understanding unit 101. In the retrieval database 106, a plurality of retrieval targets are stored to be associated with recommendation candidate data indicative of whether or not the retrieval targets are recommendation candidates. The type of the database used as the retrieval database 106 and the retrieval method of the retriever 102 are not limited and may be achieved in various forms. The retrieval result is transmitted to the dialog manager 103.

The dialog manager 103 determines a behavior which is an action to the user on the basis of the retrieval result obtained by the retriever 102. The behavior is an action such as a response to a user represented in a form of a tag and a slot. For example, the behavior is represented as a request (item) (check an item matching user's desire), offer (store=store A) (presenting store A as store desired by user), or the like. A determination method of behavior will be described later. The behavior determined is transmitted to the natural language generator 105.

Here, the dialog manager 103 refers to recommendation candidate data applied to the targets retrieved by the retriever 102 in the recommendation determination unit 104 to determine whether or not a candidate to be recommended to the user is in the retrieval result. In the determination, if a recommendable candidate is not included therein, the behavior to the user is determined on the basis of the retrieval result. Furthermore, if a recommendable candidate is included therein, whether or not a behavior to present a recommendable candidate to a user is determined using at least one of the number of the retrieval result or the number of the retrieval conditions input by the user during the interaction. The determination is performed at the same time when the behavior is determined by the dialog manager 103 or is performed to be integrated in the determination of the behavior. The determination method will be described later.

The natural language generator 105 generates a natural language presented by the user on the basis of the behavior determined by the dialog manager 103. The natural language may be generated through a method of preliminarily preparing natural languages corresponding to behaviors, method of preliminarily preparing natural languages with blanks and filling the blanks with terms included in the slots of behavior, or method of collecting a greater amount of natural languages corresponding to the behavior to learn a natural language generation model by a statistical method and generating natural languages corresponding to the behavior obtained from the dialog manager 103 on the basis of the model. Furthermore, a natural language may be presented to the user in speech through speech synthesis of the natural language.

Now, an action of the interactive system of the first embodiment will be described with reference to FIG. 2. FIG. 2 is a flowchart showing an action of the interactive system of the first embodiment.

Initially, the interactive system analyzes an input text of user in the spoken language understanding unit 101 to estimate an intention of user and a retrieval condition (step S101). Then, the retriever 102 searches the retrieval database 106 on the basis of the retrieval condition obtained in step S101 (step S102). Then, the dialog manager 103 determines whether or not a recommendable candidate is included in the retrieval result (step S103).

Here, data indicative of a recommendable candidate (hereinafter, recommendation candidate data) may be preliminarily included in the retrieval database 106, or may be applied to the candidates of the retrieval result after the search process by the retriever 102 or the dialog manager 103. Furthermore, a criterion to determine a recommendable candidate may be preliminarily set by a system manager, or may be determined arbitrarily on the basis of, for example, the data included in the candidates of the retrieval result, time, and retrieval conditions input by users. For example, a shop holding a time sale in a shopping center may become a recommendable candidate only during the time sale. Somewhere else, for example, in a travel guide post, a travel plan to be discounted during a travel schedule planned by a user may be a recommendable candidate, or a travel destination where a seasonal event such as festival is held during the travel schedule planned by a user may become a recommendable candidate.

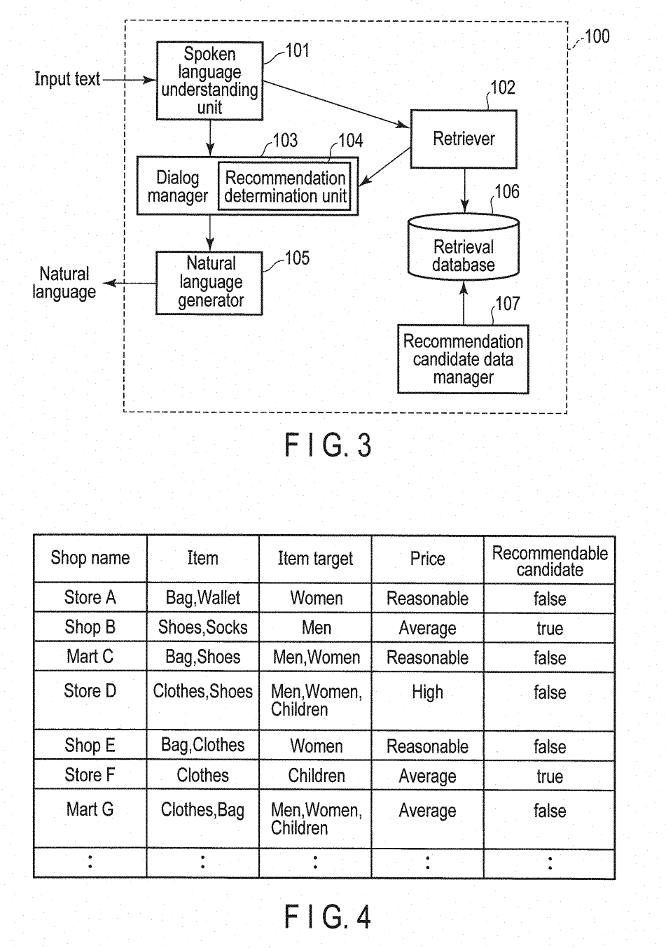

If the recommendation candidate data are preliminarily included in the retrieval database 106, a correction by a system manager and a change of recommendable candidate caused by a time lapse are required. In that case, a recommendation candidate data manager 107 is prepared as shown in FIG. 3, and in non-synchronization with the retrieval process, the recommendation candidate data of the retrieval targets stored in the retrieval database 106 or the recommendation candidate data of optional candidates in a retrieval result may be changed by the recommendation candidate data manager 107 to flexibly deal with the management of the recommendable candidates.

In step S103, if a recommendable candidate is not included in the retrieval result (No), the dialog manager 103 determines a behavior thereof while excluding presentation of a recommendable candidate from the candidates of behavior (step S104).

Here, as a method of determining behavior, there is a method of preparing data of an interaction state which shows a progress status of the interaction and performing a rulebase determination which behavior is selected from the interaction state and intention of user. Note that, the above method requires some costs in preparing a rule to determine which behavior is selected from the interaction state and intention of user, and whether or not such a behavior based on the rule is optimized is not proven. Specifically, if an input text is analyzed by the spoken language understanding unit 101 by a statistical method, and the intention of user, retrieval condition, and interaction condition are all output statistically, preparing a rule in consideration of the statistic value is very difficult. Thus, in recent years, a method of statistically determining a behavior is used.

As a statistical method, there is reinforcement learning, for example. The reinforcement learning gives positive or negative reward to a system depending on whether or not an interaction is performed as desired by a user. The system learns how much reward can be given from behaviors through trial-and-error processes on the basis of results of analysis of input texts obtained in the spoken language understanding unit 101 and the retriever 102 and retrieval results. When actually performing the interaction, a behavior which appears to achieve best reward in an analysis result or a retrieval result of an input text is selected. Thus, costs to prepare a rule by a system manager can be resolved and an optimized behavior can be performed under the designed reward. Data of the analysis result and retrieval result of the input text used as an input feature vector in the determination of behavior are derived from, for example, the intention of user, statistic value thereof, filled conditions or blank conditions in the retrieval condition, statistic value of the filled condition, the number of retrieval results, and the like.

In the reward function, specifically, there is a method of giving a greater positive reward only when a final target of a user is achieved and giving a less negative reward in other cases. Furthermore, a greater negative reward may be given when the number of the retrieval results becomes greater in the presentation of the retrieval result. Thus, the presentation of retrieval result can be suppressed when the number of the retrieval result is greater.

In step S103, if a recommendable candidate is included in the retrieval result (Yes), the dialog manager 103 including the recommendation determination unit 104 determines which behavior is suitable while the presentation of recommendable candidate is included in the candidates of behavior (step S105). At that time, the presentation of recommendable candidate may be switched with a behavior presented in a general retrieval condition or may coexist.

In step S105, when determining whether or not the presentation of recommendable candidate is performed, the presentation needs to be performed when a user does not strongly desire to narrow down the conditions such that the user does not feel dissatisfaction. Thus, to determine whether or not a recommendation candidate is presented, at least one of the number of the retrieval result or the number of the retrieval condition input by the user is used. This is because, after a user narrows down the number of candidates or tells conditions to some extent, the user does not wish further narrowing-down process.

The determination of whether or not a recommendable candidate is presented using at least one of the number of the retrieval result or the number of the retrieval condition may be performed rulebase, and therein, a threshold value is preliminarily set and a recommendable candidate is presented when the number of the retrieval conditions becomes less than the threshold value or the number of the retrieval conditions becomes more than the threshold value. In this method, reinforcement learning can be used. In addition to the reward setting of reinforcement learning of step S104, the setting allows that a greater reward is given when a recommendable candidate is accepted by a user and a negative reward is given when the recommendable candidate is denied. Then, behavior determination model is learnt by using at least one of the number of retrieval, and the retrieval condition as an input feature vector used when determining a behavior. Furthermore, in the actual interaction, an reinforcement expectation value expected reward finally obtained is calculated on the basis of the above input feature vector and behavior determination model, and a behavior of highest expected reward is selected. Thus, a behavior determination process using the reinforcement learning can be achieved. Note that various types of data explained in the description of step S104 may be used as the input feature vector for the behavior determination.

Furthermore, in the reinforcement learning, determination of steps S104 and S105 may be achieved in one reinforcement learning model. This is achieved by using the reward setting of step S105 and adding data indicative of whether or not a recommendable candidate is included in the retrieval result to the input feature vector used for the behavior determination. In that case, steps S103, S104, and S105 of FIG. 2 are integrated as a behavior determination process.

Lastly, in the natural language generator 105, a natural language is generated on the basis of the behavior determined by the dialog manager 103 (step S106). If a user further inputs an input text in response to the natural language, the process returns to step S101 and the interaction proceeds.

Now, with reference to FIGS. 4 to 7, explained will be an example of an action by the interactive system 100 to actively present a recommendable candidate to a user without causing the user to feel dissatisfaction. In this example, a user is in a shopping mall and tells a desired item and a desired price to the guide system through interaction, and the guide system presents a shop which satisfies the conditions in the shopping mall. In the determination of behavior, the behavior determination model generated by the reinforcement learning is used.

FIG. 4 shows a database stored in the retrieval database 106 of a shop in a shopping mall to which recommendation candidate data are given. The shop to be recommended is given true in the recommendable candidate field. In general, a manager of the shopping mall may determine the recommendable shop. In that case, a checkbox corresponding to each shop is prepared. For example, a manager checks the checkbox of a shop to recommend the shop, and this determination may be performed using a graphical user interface. Or, the recommendable shop may be determined on the basis of shop data or a combination of the shop data and time, for example. For example, a shop may be recommended during a period of time of discount sale. Or, a shop having a large stock may be recommended. The data registration of shops may be performed by a manager of the shopping mall or may be performed by a manager of each store (clerk or the like). Furthermore, the number of stock may be automatically checked by a separated stock management system. Only the shop discount rate of which is above a threshold value or only the shop having a stock greater than a threshold value of the shops having discount sale, may be recommended. At that time, such threshold values may be determined by a manager of the shopping mall or may be automatically adjusted such that the number of recommendable candidates becomes a certain number.

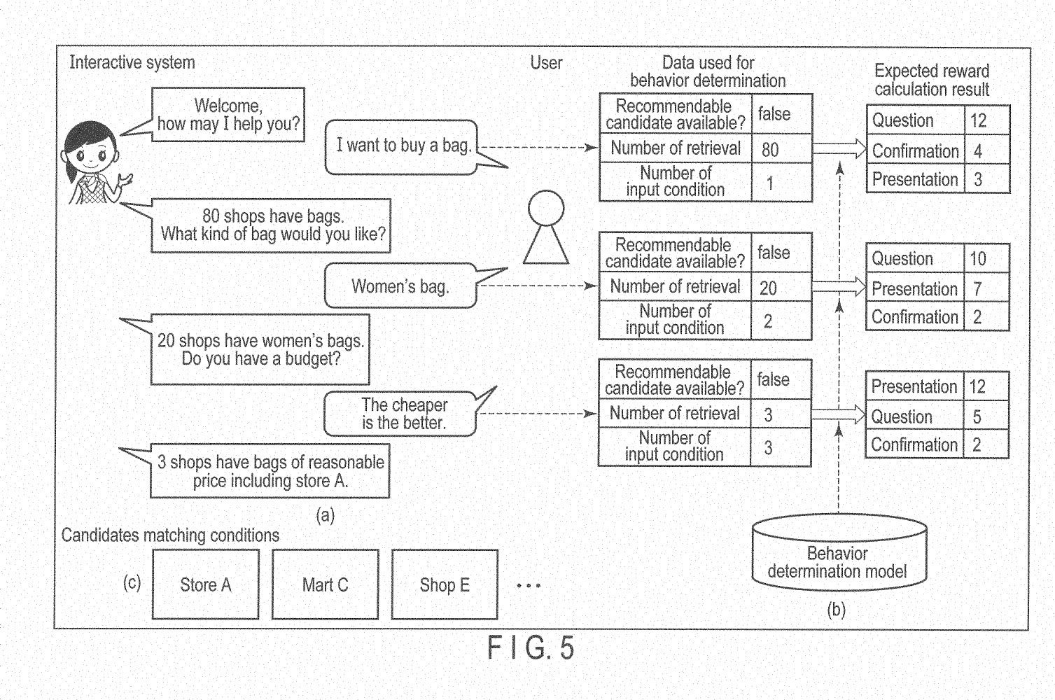

FIG. 5 shows an example of a first action of the interactive system of the first embodiment. Therein, (a) is an example of the interaction between the system and a user, (b) is an expected reward calculation result derived from data used for behavior determination retrieved on the basis of conditions extracted from the interaction and the behavior determination model, and (c) shows an example of a graphical user interface display in which candidates matching the condition are selected from the expected reward calculation result.

The first action is given when the interactive system searches the database on the basis of the conditions extracted from the interaction with a user but a recommendable candidate is not retrieved from the conditions presented by the user (presence of recommendable candidate=false), and therein, a speech of user is analyzed in each input, the retrieval condition obtained from the analysis is used for retrieval, and data used for behavior determination are set from the retrieval. An expected reward obtained in each behavior (question, confirmation, presentation) is calculated using the data used for behavior determination and the behavior determination model.

That is, to first two speeches of the user, a behavior of question which requests additional conditions to the user may expect a greater reward because the retrieval conditions are many. Thus, a question is output. Then, to a third speech of the user, a behavior of presentation which presents a candidate matching the retrieval condition may expect a greater reward. Thus, the presentation of candidate matching the retrieval condition is output to the user as a response.

Here, in the example of FIG. 5, data used for behavior determination are presence of recommendable candidate, number of retrieval, and number of input condition while other various data such as user intention and estimated probability of retrieval condition can be used. For example, if the estimated probability of retrieval condition is low, the behavior determination model in which a behavior of confirmation which confirms whether or not the estimated condition value is correct expects greater reinforcement reward. The types of behavior are three types of question, presentation, and confirmation in the example of FIG. 5 while actions such as repeating question and presenting several conditions to be selected by user may be added. Furthermore, a list of shops is displayed in the graphical user interface when the candidates matching the conditions are presented; however, a list of shops obtained in the retrieval may be displayed while narrowing down the candidates.

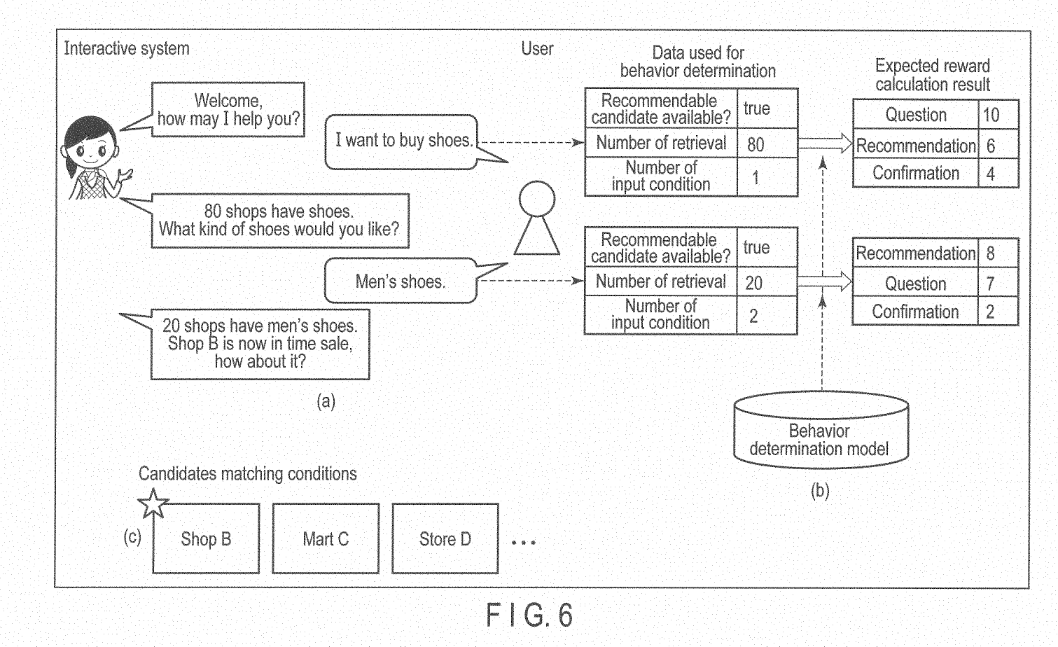

FIG. 6 shows an example of a second action of the interactive system of the first embodiment. Therein, (a) is an example of the interaction between the system and a user, (b) is an expected reward calculation result derived from data used for behavior determination retrieved on the basis of conditions extracted from the interaction and the behavior determination model, and (c) shows an example of a graphical user interface display in which candidates matching the condition are selected from the expected reward calculation result.

The second action is given when the interactive system searches the database on the basis of the conditions extracted from the interaction with a user and a recommendable candidate is retrieved from the conditions presented by the user (presence of recommendable candidate=true), and therein, a speech of user is analyzed in each input, the retrieval condition obtained from the analysis is used for retrieval, and data used for behavior determination are set from the retrieval. An expected reward obtained in each behavior (question, recommendation, confirmation) is calculated using the data used for behavior determination and the behavior determination model.

In this example, to a first speech of the user, a behavior of question which requests additional conditions to the user may expect a greater reward because the retrieval conditions are many. Thus, a question is output. Then, to a second speech of the user, a behavior of recommendation may expect a greater reward because the retrieval condition is narrowed down and the presence of recommendable candidate is true. Thus, the presentation of recommendable candidate is output to the user as a response.

That is, if a recommendable candidate is included in the result of retrieval performed on the basis of the intention of user, data related to the presence of the recommendable candidate in the data used for behavior determination change, and thus, the calculation result of the expected reward changes and the behavior changes accordingly. Specifically, the retrieval condition obtained from the analysis of the second speech of user, while the number of retrieval result and the number of the input condition do not change from the interaction of the second speech in FIG. 5, a behavior of recommendation is suitable here instead of a behavior of question. Thus, a list of shops matching the condition is presented together with a natural language clearly recommending a recommendable candidate. Thus, a behavior presented when a recommendable candidate to the user is included is selected earlier than a case where a recommendable candidate is not included, and the interaction can actively present a recommendable candidate to the user. Furthermore, as in the first speech of user, if the number of retrieval results is too many, a behavior of presenting a recommendable candidate is not performed. Thus, a problem that a user feels dissatisfaction to the system because recommendable candidates are presented while the user still wish to narrow down the candidates can be solved, and a recommendable candidate can be presented at a suitable time.

Note that, as in FIG. 6, when a natural language presenting a recommendable candidate is shown to a user, the reason why the candidate is recommended may be included in the natural language. The user may become interested in the candidate and may actually visit the recommended shop. Furthermore, if a plurality of recommendable candidates are included in a retrieval result, a natural language may present one of the candidates to a user or may present all candidates to a user at once. Furthermore, a natural language may present a plurality of recommendable candidates with the reason why they are recommended. For example, a text may be “Shop B and store F are in time sale and mart G is in new opening sale.”

As shown in FIG. 6, a list of shops matching the conditions displayed on the graphical user interface may be arranged such that a recommendable candidate is listed first and marked for eye catch or such that a recommendable candidate is displayed in a position different from the other candidates for eye catch. If there are a plurality of recommendable candidates, such candidates may be all marked. Such a display method may be performed on the basis of the retrieval result obtained from the current retrieval condition even when a behavior other than presentation of recommendable candidates, that is, a behavior of question or the like is presented to the user.

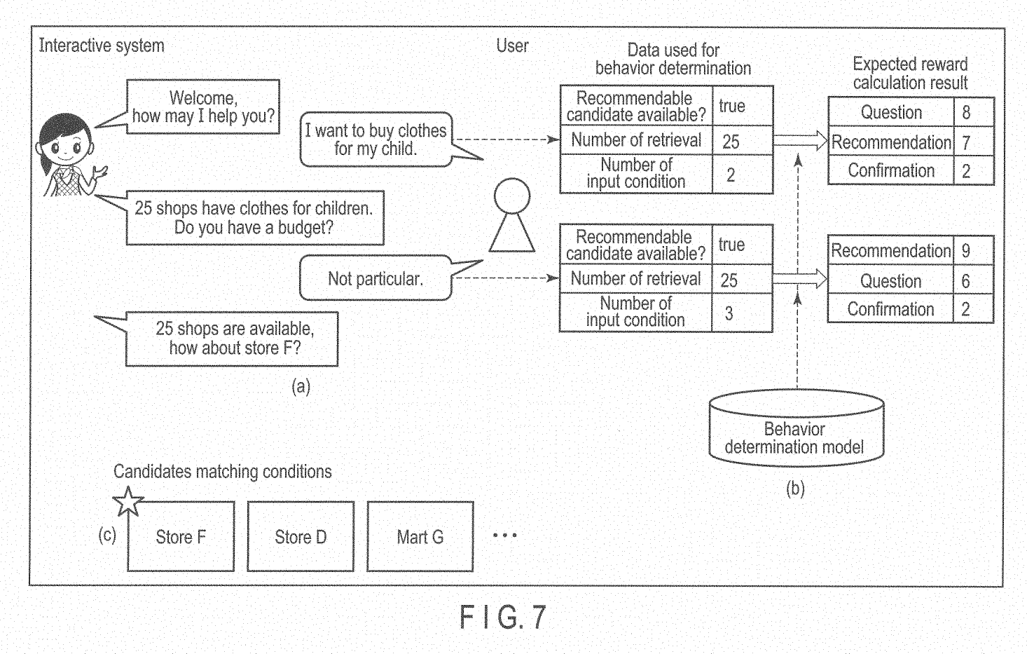

FIG. 7 shows an example of a third action of the interactive system of the first embodiment. Therein, (a) is an example of the interaction between the system and a user, (b) is an expected reward calculation result derived from data used for behavior determination retrieved on the basis of conditions extracted from the interaction and the behavior determination model, and (c) shows an example of a graphical user interface display in which candidates matching the condition are selected from the expected reward calculation result. As in the first and second actions, a speech of user is analyzed in each input, the retrieval condition obtained from the analysis is used for retrieval, and data used for behavior determination are set from the retrieval. An expected reward obtained in each behavior (question, recommendation, confirmation) is calculated using the data used for behavior determination and the behavior determination model.

The third action is given when the interactive system searches the database on the basis of the conditions extracted from the interaction with a user and a recommendable candidate is retrieved from the conditions presented by the user (presence of recommendable candidate=true), and therein, a behavior changes to present a recommendable candidate depending on a change of the number of the retrieval condition input by the user. A behavior of question expects highest reward as calculated from the data user for behavior determination obtained in the first speech of the user; however, a behavior of recommendation to present a recommendable candidate is performed after the second speech of the user even if it does not change the number of retrieval. This is because the number of retrieval conditions (number of input conditions) input therein increases and a calculation result of expected reward changes accordingly. Thus, a recommendable candidate can be actively presented to the user when the user gives some retrieval conditions to the system and feels no more narrowing-down process is required.

As can be understood from the above, the interactive system of the first embodiment uses at least one of the number of the retrieval result and the number of conditions told by a user to the system if a recommendable candidate is included in retrieval targets in a database which is searched with a condition obtained in the interaction with the user, and determines whether or not a behavior to present the recommendable candidate is performed is determined. Thus, the recommendable candidate can be actively recommended to the user such that the user does not feel dissatisfaction to the service.

### Second Embodiment

In the interactive system of the first embodiment, the data indicative of whether or not each of the retrieval targets is recommendable to a user are used to determine the behavior of the system. Here, a degree of recommendation is also effective. Thus, in the interactive system of the second embodiment, a score showing a degree of recommendation (hereinafter, recommendation score) is applied to each of the retrieval targets and whether or not a retrieval target is recommended to a user is determined using the score. A recommendable candidate with a higher recommendation score can be recommended to the user.

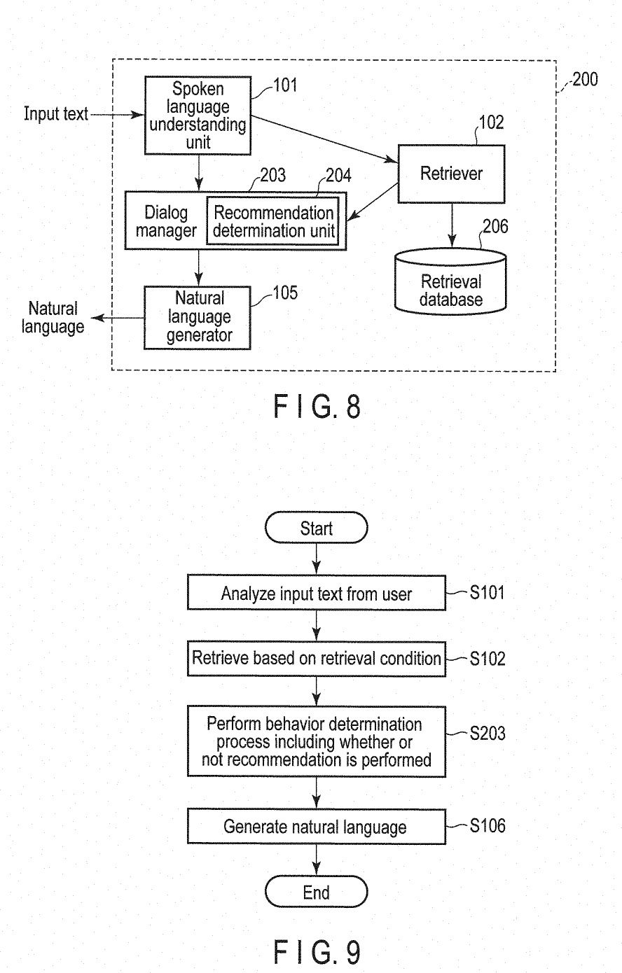

FIG. 8 is a block diagram showing the structure of an interactive system of the second embodiment. The interactive system 200 of the second embodiment includes, as in the first embodiment, a spoken language understanding unit 101, retriever 102, and natural language generator 105. A dialog manager (score) 203 including a recommendation determination unit 204, and retrieval database (score) 206 are different from the dialog manager 103 including the recommendation determination unit 104 and the retrieval database 106 of the first embodiment, and they perform processes on the basis of the recommendation scores.

That is, the retrieval database 206 includes a recommendation score of each candidate, and in this respect, it is different from the retrieval database 106. Note that the first embodiment indicates a case where data indicative of a recommendable candidate are applied to a retrieval result in the retriever 102 and the dialog manager 103; however, a recommendable score may be applied in the retriever and the dialog manager. In that case, the retrieval database 206 functions similarly to the retrieval database 106, and a retriever 202 which is different from the retriever 102 is adopted if the recommendation score is applied in the retriever. An application method of recommendation score may be determined by a system manager as in the first embodiment or may be determined arbitrarily on the basis of the data included in the candidates in the retrieval result, time, retrieval conditions input by users, and the like. At that time, a degree of each recommendation score may be determined such that a higher recommendation score is applied to a candidate having a high discount rate during a time sale. Furthermore, the weighting addition of recommendation scores derived from various methods may be used as scores actually used.

In the dialog manager 203 including the recommendation determination unit 204 determines the behavior using an analysis result of an input text from the spoken language understanding unit 101 and a retrieval result of the retriever 102, and determines whether or not a candidate with a high recommendable score is presented to a user using the recommendation score included in the retrieval result and at least one of the number of retrieval result and the number of conditions input by users.

Now, an action of the interactive system of the second embodiment will be explained with reference to FIG. 9. Note that FIG. 9 is a flowchart showing the action of the interactive system of the second embodiment and steps S101, S102, and S106 are the same as those in the first embodiment. Thus, the same reference numbers are applied thereto and their detailed description will be omitted.

In step S203 of FIG. 9, the behavior is determined by the dialog manager 203 including the recommendation determination unit 204 using an analysis result of an input text from the spoken language understanding unit 101 and a retrieval result of the retriever 102, and determines whether or not a candidate with a high recommendable score is presented to a user using the recommendation score included in the retrieval result and at least one of the number of retrieval result and the number of conditions input by users.

The determination of whether or not a candidate with a high recommendation score is presented may be performed rulebase by setting a threshold value preliminarily and a recommendable candidate is presented to a user when the recommendation score becomes more than the threshold value and the number of the retrieval conditions becomes less than the threshold value, or the number of the retrieval conditions becomes more than the threshold value. In this method, reinforcement learning can be used. In addition to the reward setting of reinforcement learning of step S104, the setting allows that a positive reward in proportion to the recommendation score is given when a recommendable candidate is accepted by a user and a certain negative reward is given when the recommendable candidate is denied. Then, behavior determination model is learnt by using at least one of the number of retrieval and the retrieval condition, and the highest recommendation score in the retrieval result as an input feature vector used when determining a behavior. Thus, in the actual interaction, an expected reward finally obtained is calculated on the basis of the above input feature vector and behavior determination model, and a behavior of highest expected reward is selected.

Note that various types of data explained in the description of step S104 may be used as the input feature vector for the behavior determination. Furthermore, an average or dispersion of the recommendation scores and highest to Nth recommendation scores may be used at the same time. Thus, when as many candidates of high recommendation scores as possible are included in the retrieval result, the system can actively present the candidates with high recommendation scores.

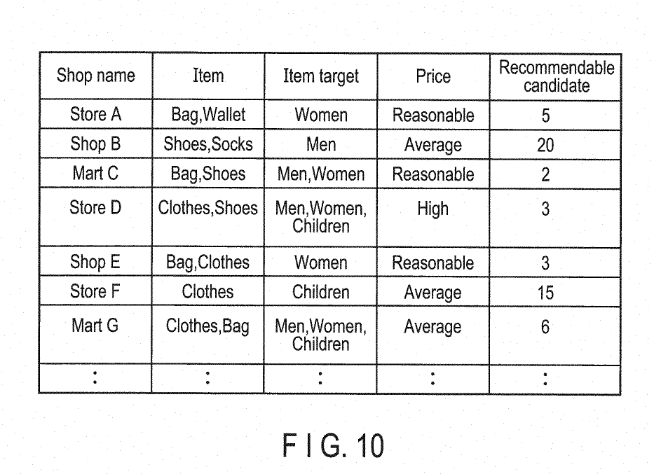

Now, with reference to FIGS. 10 to 12, an example of an action by the interactive system 200 to actively present a candidate with a high recommendation score will be explained. In this example, a shopping mall guide system is used.

FIG. 10 shows a database stored in a database of a shopping mall to which recommendation scores are given. The shop to be recommended is given a high recommendation score. As in the first embodiment, in general, a manager of the shopping mall may determine the recommendation scores. Or, the recommendation scores may be determined automatically on the basis of shop data or a combination of the shop data and time, for example. Or, the weighting addition of the scores obtained various methods may be used. If a manager of the shopping mall manually inputs values of the recommendation scores, the manager may input values of the recommendation score to each shop, or the manager may add some priority degrees such as large, medium, or small to each candidate. The priority degrees later converted into scores and stored in the database. Or, the priority degrees may be registered in the database and later converted into scores in the retriever 102 and the dialog manager 203 to be used as input feature vector in the behavior determination. If the scores are calculated automatically on the basis of the store data and the like, the manager of the shopping mall may add the scores to the shop matching the conditions (for example, a shop having a time sale), or the scores may be determined by weighting addition.

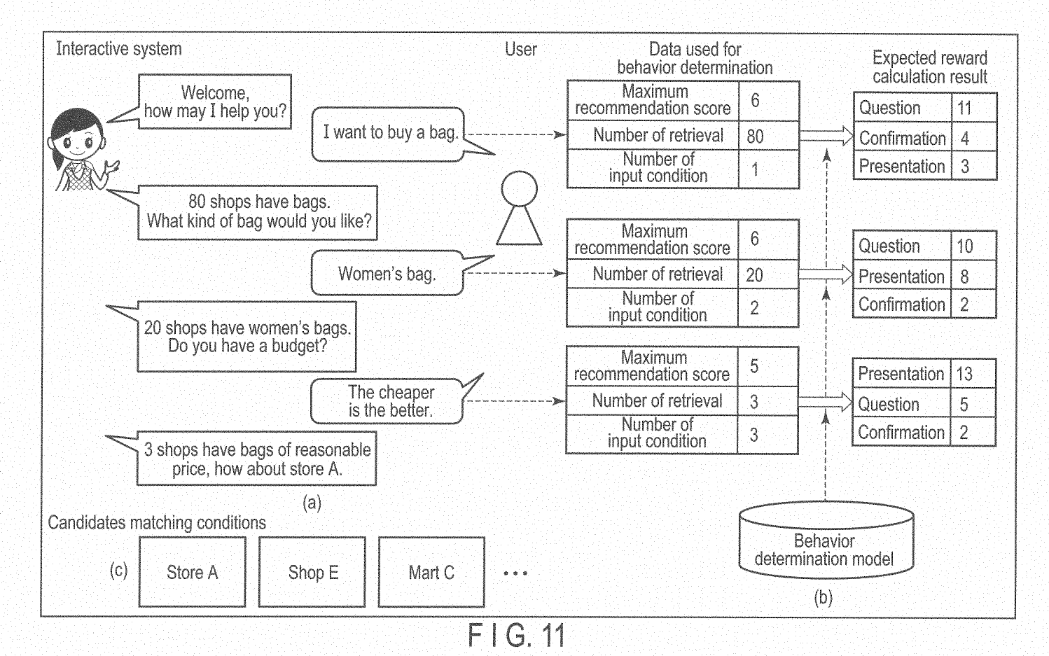

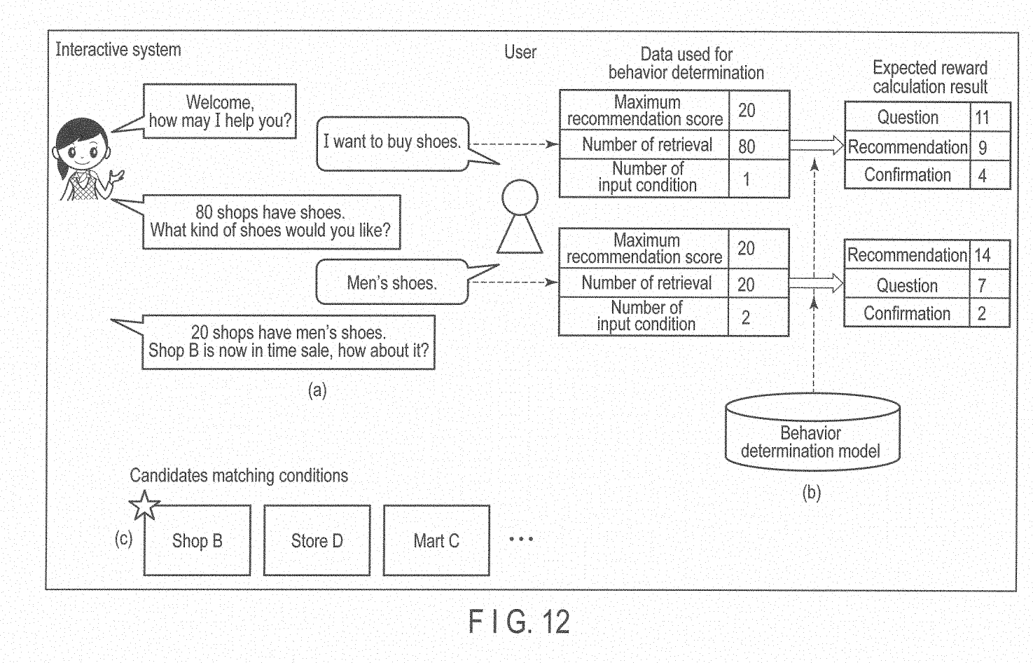

FIGS. 11 and 12 show first and second actions using the recommendation scores registered in the database of FIG. 10 in the interactive system of the second embodiment. In the examples of FIGS. 11 and 12, the number of candidates retrieved on the basis of the conditions given by a user and the number of conditions input by the user are the same while the maximum recommendation scores in the retrieval result are different. In the interaction of the FIG. 12, a recommendable candidate with higher recommendation score is presented faster. That is, a recommendable candidate with higher recommendation score can be actively presented to the user.

Note that, in the last natural language in the example of FIG. 11, a shop of highest recommendation score in the retrieval result is presented to a user; however, if a recommendation score is not so high, a natural language may present ordinary retrieval results without recommending the shop of highest recommendation score. If such a response is desired, a threshold value may be set to exclude candidates having a recommendation score below the threshold value, and a natural language of ordinary retrieval result is presented. Or, reinforcement learning may be designed to give a further negative reward to a recommendable candidate if it is not accepted by a user. In this method, a border line of the recommendation scores where a recommendable candidate is withhold from the recommendation even when positive reward given to that candidate is considered.

A list of shops matching the conditions displayed on the graphical user interface may be arranged such that shops are listed from high to low recommendation scores, and a mark may be added to the candidate with the highest recommendation score, or the candidate with the highest recommendation score may be displayed separately from the other candidates for eye catch. Not only the candidate with the highest recommendation scores but also candidates with recommendation scores close to the highest score may be marked or displayed in a different spot for eye catch. The size or color of the mark may be changed depending on the degree of the score.

As can be understood from the above, the interactive system of the second embodiment uses a recommendation score included in the retrieval result on the basis of the conditions obtained from the interaction with a user, and at least one of the number of the retrieval result and the number of conditions told by a user to the system, and determines whether or not a behavior to present the recommendable candidate is performed is determined. Thus, the recommendable candidate with a higher recommendation score can be actively recommended to the user.

Note that the interactive systems 100 and 200 of the first and second embodiments may be achieved using, for example, a conventional computer device as a basis hardware device. That is, the spoken language understanding unit 101, retriever 102, dialog manager (true-false) 103 including the recommendation determination unit 104, natural language generator 105, and retrieval database (true-false) 106 of the first embodiment, and the spoken language understanding unit 101, retriever 102, dialog manager (score) 203 including the recommendation determination unit 204, natural language generator 105, and retrieval database (score) 206 of the second embodiment are executed by a processor mounted in the computer device.

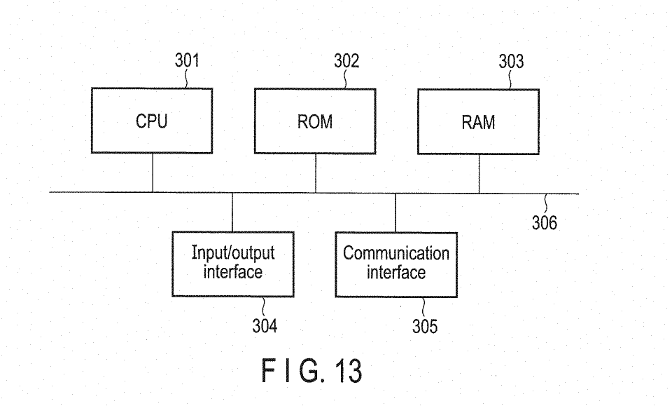

The computer device applicable to the interactive system including such a support device includes, as shown in FIG. 13, a control device such as central processing unit (CPU) 301, memory device such as read only memory (ROM) 302 or random access memory (RAM) 303, microphone, operation input device, input/output interface 304 to which a display device or the like is connected, communication interface 305 which is connected to the network to perform communication, and bus 306 connecting the units together. The above program may be preliminarily installed in a computer device, or the above program may be arbitrarily installed in a computer device through a memory medium such as CD-ROM or through the network distribution. Furthermore, each process may be achieved using a memory installed in the computer device, external memory, hard disk, or memory medium such as CD-R, CD-RW, DVD-RAM, or DVD-R.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An interactive system comprising:
a database configured to store a plurality of retrieval targets to be associated with recommendation candidate data indicative of whether or not a retrieval target is a recommendation candidate; and
a controller configured to set a retrieval condition based on input data obtained from interaction with a user, to retrieve a target corresponding to the retrieval condition from the database, to determine whether or not a recommendation candidate is included in the retrieved target from the recommendation candidate data associated with the retrieved target, to determine an action to the user based on a result of the retrieval if the recommendation candidate is determined to be not included, to determine whether or not presentation of the recommendation candidate to the user is performed based on at least one of the number of the retrieved target and the number of input in the interaction with the user if the recommendation candidate is determined to be included, and to perform a reply process corresponding to the determined action.

2. The interactive system of claim 1, wherein the recommendation candidate data is added to the database when the retrieval target is registered or updated.

3. The interactive system of claim 1, wherein the recommendation candidate is determined on the basis of the retrieval target or a combination of the retrieval target and time.

4. The interactive system of claim 1, wherein the controller determines whether or not each of the retrieved target is the recommendation candidate on the basis of the result of the retrieval and input data from the interaction with the user.

5. The interactive system of claim 1, wherein the controller determines whether or not each of the candidate in the result of the retrieval is the recommendation candidate on the basis of candidate data of the result of the retrieval or a combination of the candidate data of the result of the retrieval and time.

6. The interactive system of claim 1, wherein the controller includes an action determination model configured to use at least one of the number of the retrieval condition determined on the basis of the number of candidates of the result of the retrieval and input data from the interaction with the user, and data indicative of whether or not the recommendation candidate is included in the result of the retrieval as a minimum input, and the action determination model being obtained by performing reinforcement learning with a reward design in which a greater positive reward is given if the recommendation candidate is accepted by the user and a negative reward is given if the recommendation candidate is not accepted by the user, and wherein the controller determines the action on the basis of the action determination model.

7. The interactive system of claim 1, wherein the recommendation candidate data is represented by a score, and the controller uses at least one of a score of a candidate with the highest score in the result of the retrieval, the number of candidates of the result of the retrieval, and the number of the retrieval condition determined on the basis of the input data of the interaction with the user in order to present the candidate with the highest score to the user where the presentation becomes more active with increase of the score.

8. The interactive system of claim 7, wherein the controller includes an action determination model which is obtained by performing reinforcement learning with a reward design in which a positive reward in proportion with the score is given if the recommendation candidate with the highest score is accepted by the user and a negative reward is given if the candidate is not accepted by the user, and determines the action based on the action determination model.

9. An interaction method of an interactive system, the method comprising:
storing a plurality of retrieval targets to be associated with recommendation candidate data indicative of whether or not a retrieval target is a recommendation candidate in a database;
setting a retrieval condition based on input data obtained from interaction with a user;
retrieving a target corresponding to the retrieval condition from the database;
determining whether or not a recommendation candidate is included in the retrieved target from the recommendation candidate data associated with the retrieved target;
determining an action to the user based on a result of the retrieval if the recommendation candidate is determined to be not included;
determining whether or not presentation of the recommendation candidate to the user is performed based on at least one of the number of the retrieved target and the number of input in the interaction with the user if the recommendation candidate is determined to be included; and
performing a reply process corresponding to the determined action.

10. A non-transitory computer-readable storage medium having stored thereon a computer program which is executable by a computer used in an interaction program of an interactive system, the computer program comprising instructions capable of causing the computer to execute functions of:
setting a retrieval condition based on input data obtained from the interaction with a user;
retrieving a target corresponding to the retrieval condition from in a database in which a plurality of retrieval targets are stored to be associated with recommendation candidate data indicative of whether or not a retrieval target is a recommendation candidate;
determining whether or not a recommendation candidate is included in the retrieved target from the recommendation candidate data associated with the retrieved target;
determining an action to the user based on a result of the retrieval if the recommendation candidate is determined to be not included;
determining whether or not presentation of the recommendation candidate to the user is performed based on at least one of the number of the retrieved target and the number of input in the interaction with the user if the recommendation candidate is determined to be included; and
performing a reply process corresponding to the determined action.
